(19) United States
(12) Patent Application Publication
(10) Pub. No.: US 2021/0387221 A1
(43) Pub. Date: Dec. 16, 2021

(54) PRESSURE PUMPING SYSTEM WITH INTEGRATED WEATHER MONITORING CONTROLS

(71) Applicant: AKURATE DYNAMICS, LLC, Houston, TX (US)

(72) Inventors: Andrew Hodgkinson, Spring, TX (US); Trey Cook, Houston, TX (US)

(21) Appl. No.: 17/347,371

(22) Filed: Jun. 14, 2021

Related U.S. Application Data
(60) Provisional application No. 63/038,854, filed on Jun. 14, 2020.

(51) Int. Cl. B05B 12/12; B05B 9/04

(52) U.S. Cl. CPC B05B 12/12; B05B 9/0406

(57) ABSTRACT

A spray coating system has integrated weather monitoring controls. The system can include a dispenser with onboard control unit; an integrated apparatus for monitoring environmental conditions (temperature, humidity, wind etc.); and communication interface for wired, wireless, internet of things (IOT), or other communications. The system monitors weather conditions in the direct vicinity of the spray equipment and informs coating applicators immediately to prevent faulty coating applications associated with incompatible environmental conditions.

### CROSS-REFERENCE TO RELATED APPLICATIONS

This application claims the benefit of U.S. Provisional Appl. No. 63/038,854, filed Jun. 14, 2020, which is incorporated herein by reference.

### FIELD OF THE DISCLOSURE

The subject matter of the present disclosure generally relates to structural coating application procedures. More specifically, it relates to a system and method for enhancing the spray-on, structural coating application process by integrating weather sensors with IOT technology directly into a plural component dispenser.

### BACKGROUND

The first weather tools can be traced back to the 1400s when a Korean prince developed the first standard rain gauge. The first thermometer was invented in 1593 and the barometer was developed in the late 1600s. Over time, these weather tools were improved and refined and were sold together with wind speed and direction meters creating the first weather stations. In the early 1800's and 1900's, weather stations typically consisted of a few specialized analog tools. Humidity gauges measured the moisture content in the air, while rain gauges and barometers helped determine previous and future rainfall. This information could then be tracked in order to identify trends. Today, there are digital weather stations and many Wi-Fi weather stations with wireless internet connectivity that can better consolidate and report information so it is easy to view and understand. Some weather stations can even connect to smartphone apps or online services so people can access their weather information from anywhere. While many in the coatings application industry provide technicians rely on separate instruments to monitor local weather conditions, no patents were found that incorporated weather stations, IOT, Al and a software application with plural component dispensers.

### SUMMARY OF THE DISCLOSURE

The device herein disclosed and described provides a solution to the shortcomings in the prior art through the disclosure of a plural component dispenser with onboard, ‘smart’ weather station. An object of the disclosed subject matter is to improve the safety and effectiveness of the coatings application process. For example, a coating crew is spraying a two-part insulation on the exterior of a roof on a coastal airport. Over the course of the day, weather on the coast changes quickly and humidity levels increase beyond the curing threshold recommended by the coating's manufacturer. The weather station on the dispenser detects this change, generates a system alarm that stops the proportioning pump, and instantly alerts crew members and the manager that they need to stop spraying immediately via their smart phones to avoid a coating failure.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of a system with integrated weather monitoring controls according to the present disclosure for applying spray coating.

FIG. 2A shows a schematic view of the disclosed system being operated.

FIG. 2B shows a perspective view of the disclosed system being operated.

FIG. 3 shows a representative view of the system's operation.

FIG. 4 is a flowchart showing the system's operation according to the present disclosure.

Other aspects of the present disclosure shall be more readily understood when considered in conjunction with the accompanying drawings, and the following detailed description, neither of which should be considered limiting.

### DETAILED DESCRIPTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the disclosed system are elements that are well-known in the prior art and will not be discussed in detail for this disclosure.

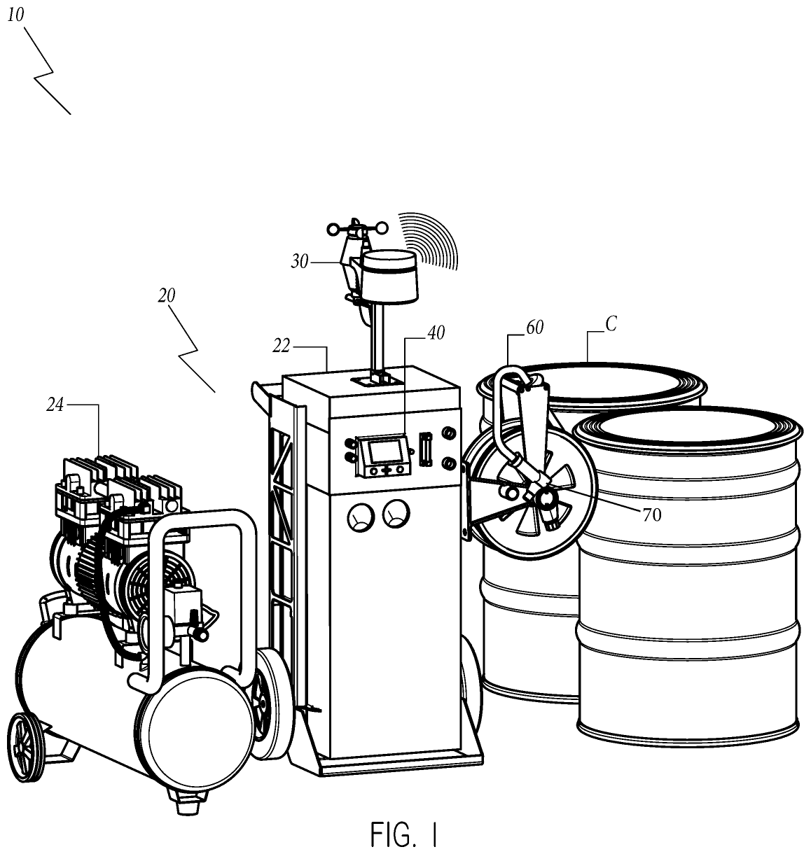

FIG. 1 shows a preferred embodiment of a spray rig or system 10 with integrated weather monitoring controls according to the present disclosure for applying spray coating. As shown, the system includes, but not limited to, a pump apparatus 20 having a pneumatic dispenser 22 and an air compressor 24. The pneumatic dispenser 22 has a hose reel 60, an applicator 70, a control unit 40, a smart weather station or integrated environmental monitoring apparatus 30. The control unit 40 can include a user interface as shown. Containers C for the spray coating material are also shown. In the current arrangement, the integrated environmental monitoring apparatus 30 (or at least some of the monitoring sensors of the apparatus 30) is disposed on the dispenser 22. Other arrangements are possible in which the apparatus 30 (or other monitoring sensors) can be mounted remotely from the dispenser 22, such as being mounted on a tripod near an application site where the spray coating is to be applied.

Other embodiments of the pump apparatus 20 can include double and single chemical coating dispensers (22) and can include other dispensing means, such as but not limited to hydraulic pumps etc. The control unit 40 of the spray rig 10 can have an onboard microcontroller (including but not limited to arduino etc.) with buffer memory and can use Zigbee wireless protocol communication technology that collects data from the integrated environmental monitoring apparatus 30 and transmits it to a multitude of receivers (such as LAN, WAN, WiFi, cellular networks etc.).

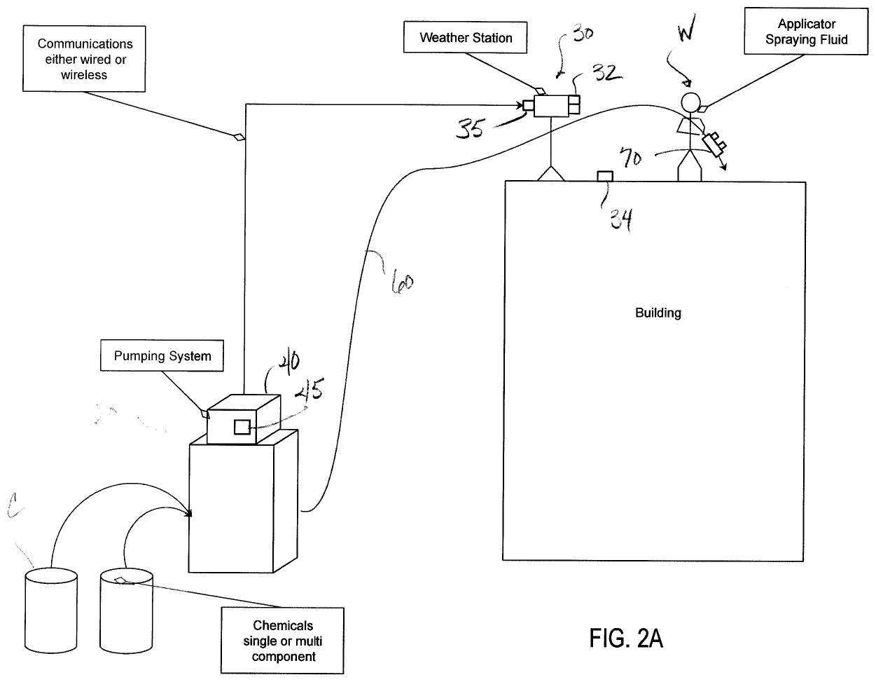

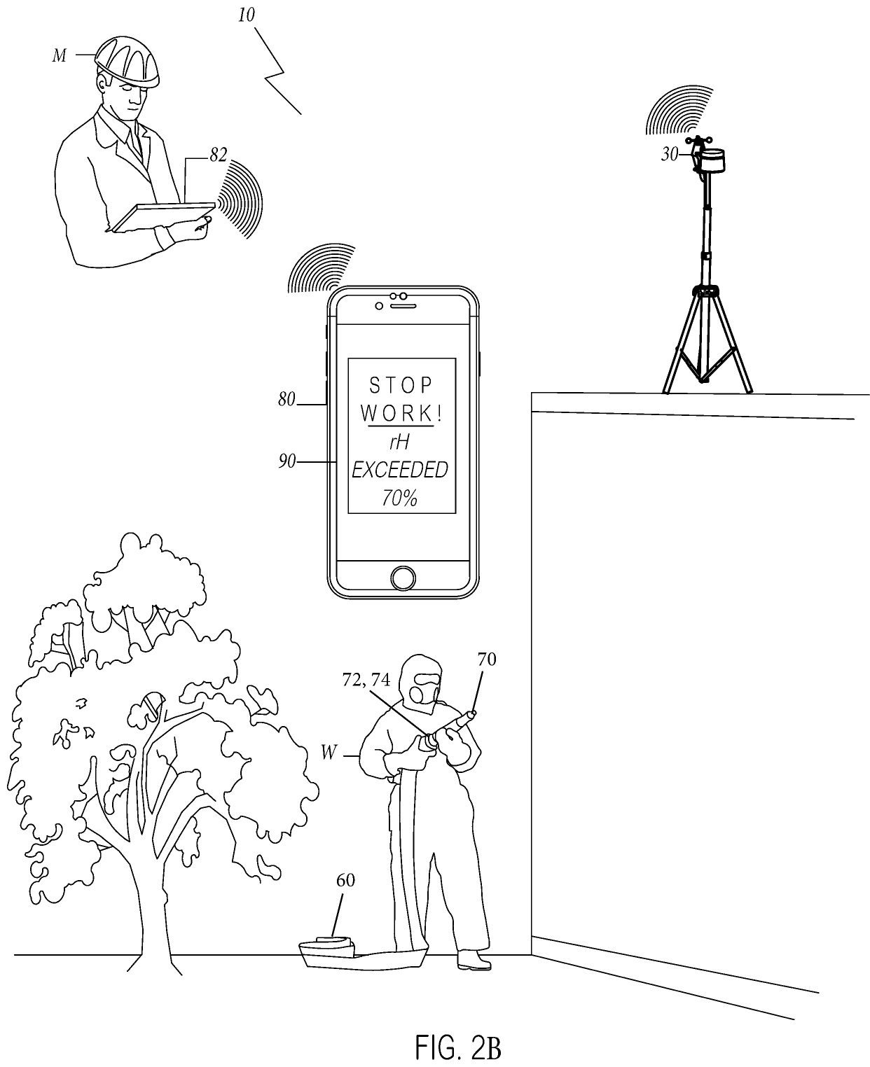

FIG. 2A shows a schematic view of the disclosed spray rig 10 being operated. The pumping apparatus 20, which can include a pneumatic dispenser and compressor as noted above or can use some other pumping arrangement, connects to storage containers C of the spray coatings components. In general, the spray coating can include a single or multiple components. The pumping apparatus 20 pumps the spray coating through a delivery line 60 to an applicator 70 held and operated by a worker W at a work location, such as on a roof of a building, where the spray coating is to be applied. The applicator 70 can typically include a spray gun or other dispensing tool for spaying the coating.

The integrated environmental monitoring apparatus 30 of the spray rig 10 is disposed in proximity to the work location where the spray coating is to be applied so that local conditions can be monitored by the sensors 32 of the station 30 as the application process is performed. Accordingly, the environmental monitoring sensors 32 are remotely mounted in proximity to the applicator 70 and communicates wirelessly or with a wired communication to the pumping apparatus 20.

In general, the integrated environmental monitoring apparatus 30 can monitor conditions suited to the type of spray coating being applied. Many chemical compositions have particular temperatures and humidity conditions under which the spray coating needs to be applied. If the environmental temperature is too high or too low or if the humidity level is too high, the spray coating may not properly cure and may not perform according to its intended use. Other conditions can be monitored.

In this way, the system 10 can enhance the safety of structural spray coating applications. For example, it has been well-documented that when roofing companies fail to understand weather conditions when applying coatings, these coatings can fail to cure causing an unstable, ‘runaway’ reaction and off-gassing of toxic solvent vapors for months—rendering a structure uninhabitable.

For example, the environmental monitoring sensors 32 can include independent sensors configured to measure a plurality of the conditions selected from the group consisting of wind speed, wind direction, ambient temperature, humidity, barometric pressure, and the like. Moreover, a surface to be coated with the spray coating may need to have a particular dryness and temperature for the spray coating to be applied properly. To that end, the integrated environmental monitoring apparatus 30 may include or may interface with a sensor 34 for monitoring substrate moisture content and/or substrate temperature. These and other sensors 32 can be used to monitor various conditions.

The integrated environmental monitoring apparatus 30 can communicate through wireless or wired communications with the pumping apparatus 20, where the control unit 40 and processing may be located to monitor the sensed conditions and initiate alerts and the like. Should the sensed conditions fall outside of specific specifications for the spray coating and its proper application, the system 10 can initiate alerts, stop application, stop pumping, and perform other operations. For example, the applicator 70 (e.g., spray gun) operated by the worker may have a user interface 72 that provides an alert (audio and/or visual) or details of the alerted condition. The applicator 70 may have an electronic control 74 that disengages or deactivates the ability of the application to dispense the spray coating. The control unit 40 of the pumping apparatus 40 may have a user interface that provides an alert (audio and/or visual) or details of the alerted condition. The pumping apparatus's control unit 40 may have an electronic control that shuts off the delivery of the spray coating or the like.

FIG. 2B shows a perspective view of worker W operating spray rig 10. The integrated environmental monitoring apparatus 30 of the spray rig 1 detects an ambient humidity value (or other condition) that exceeds the spray coating product's threshold, specification, or set point. A software application 90 sends an alert wirelessly to the worker W and optionally to a manager M. The alert can indicate that work needs to be suspended immediately to prevent the curing process from failing. The alert can take the form of vibrating text alert on their personal mobile devices (such as cell phone 80 of the worker W or a device 82 of the manager M). The alert can take the form of an audio/visual alarm for a user interface 74 on the applicator 70 used by the worker, or the alert can take the form of a control to the trigger 72 on the applicator 70 suspending dispensing of the spray coating.

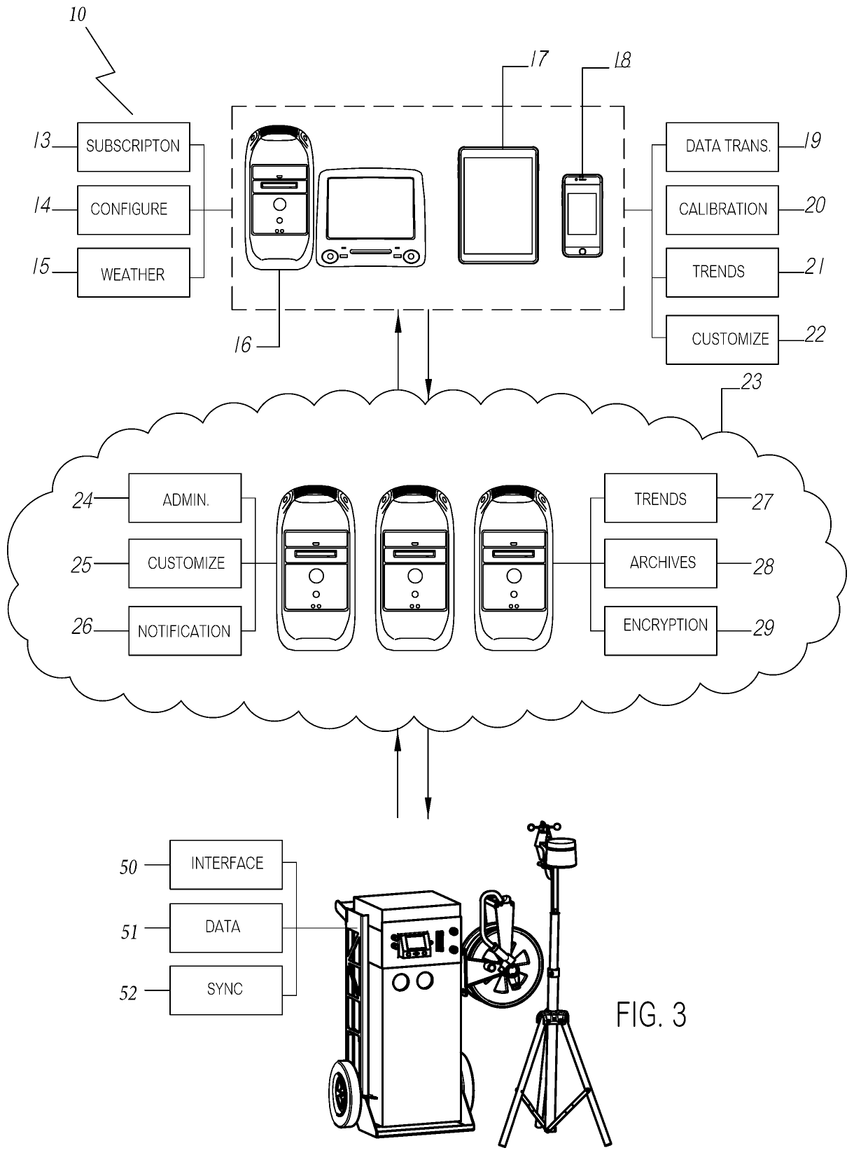

The alert can also be sent to a cloud network (23: FIG. 3) and other stakeholders as configured by the operations manager M. The system's software app 90 can be written using code that may include, but not be limited to: Java, C++™, Visual Basic™, Linux™, Basic™ and the like. The software application 9 can also compatible with a plurality of operating systems such as, but not limited to: Windows™, Apple™, and Android™, and compatible with a multitude of hardware platforms such as, but not limited to: personal desktops, laptops, tablets, smartphones and the like.

FIG. 3 shows a representative view of the disclosed system 10 in which stakeholders (including but not limited to: workers, crew leaders, operation managers, facility managers etc.) have access to the system's software. The system 10 can perform functions such as but not limited to: subscriptions 13 (registering spray rigs, contact information, online payments etc.); spray rig configurations 14 (on/off times, threshold presets, chemical types etc.); weather parameters 16 (sensor types needed etc.); preferred data transfer methods 19 (wireless, WiFi, USB, and the like); sensor calibrations 20 (both locally and remotely); 21 trend analysis (forecasting, chemical compatibilities etc.); and customization 22 (regional scheduling, alert types, etc.). FIG. 3 shows spray rig 1 having local operations such as but not limited to: graphical user interface 50 (compatible with PLC and SCADA platforms); data gathering operations and setup 51 (set to be gathered to local memory or transmitted to cloud network 23 if permissions granted); syncing sensors 52 with local forecasts stored on cloud network 23.

FIG. 3 also shows users and components of the spray rig 10 connected by means of cloud network 23. The cloud network 23 can have algorithms and routines, such as but not limited to: administrative functions 24 (user demographics, sensor registrations, online payments via Venmo, PayPal etc.); customization 25 (sensor parameters such as sampling time and duration, power on time, dormant mode, time presets, transmission schedules, transmission rates, website, graphical user interface, backend management; notifications 26 (SMS, text, email, etc.), trend reporting 27 (trend summaries etc.); data archives 28 (directory structures, daily data backups etc.) and encryption 29 (such as Advanced Encryption Standard, Rivest-Shamir-Adleman, and Triple Data Encryption Standard, etc.); and data syncing 52 with other peripheral devices 80, 82.

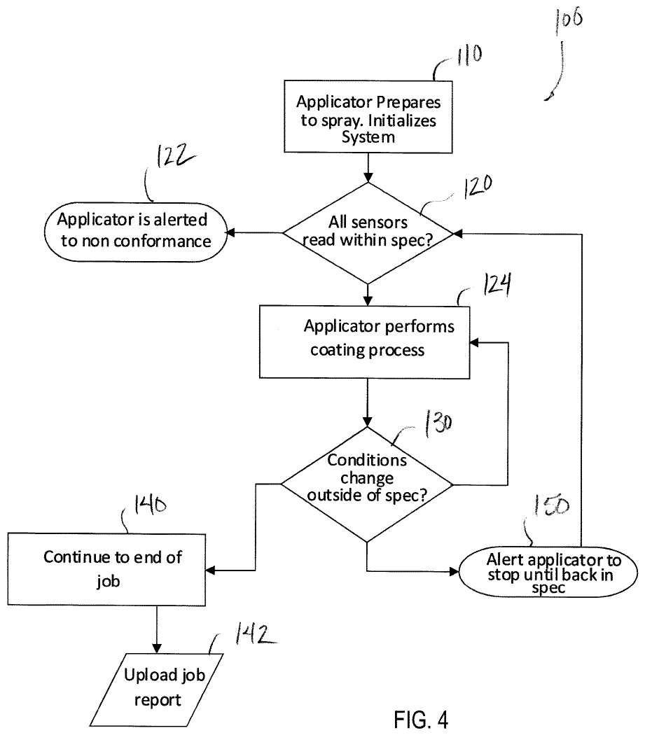

FIG. 4 is a flowchart showing a process 100 for the system's operation according to the present disclosure. During start-up of an application (i.e., “job”), the system 10 prepares to spray the spray coating as the worker W prepares to spray using the application 70, and the system is initialized so the pressure is built up to the spray coating (Block 110). The system 10 determines whether all of the monitoring sensors 32 read that conditions are within set specifications or set points (Decision 120). As noted, the monitored conditions can include. If not, the interface device 72 of the applicator 70 and/or the device 80 of the worker W is alerted to non-conformance of the current conditions (Block 122). In general. Alternatively, the control device 74 of the applicator 70 may prevent application of the spray coating under the conditions. If practical, the pump apparatus 20 of the system 10 may be shut down. Overrides and manual controls can be available.

If the conditions are within specifications (Yes at Decision 120), the pumping apparatus 20 and the applicator 70 can begin the coating process (Block 124). During application, the system 10 continues to monitor the current conditions measured by the monitoring sensors 32 to determine whether any one or more of the conditions have changed outside of the specifications (Decision 130). If conditions have not changed outside of specifications (No at Decision 130), then the system 10 continues performing the coating process (Block 124) and continues to the end of the job (Block 142) as long as the conditions remain within specifications. At the end of the job, the system 10 records a job report. When remote communications are available, the system 10 can upload the job report for later review and analysis (Block 142). Accordingly, the control unit 40 can monitor the integrated environmental monitoring sensors 32 for each individual job. The control unit 40 has a communication interface 45 that connects with a communication interface 34 of the apparatus 40 to obtain sensed conditions. In turn, the control unit 410 can record the job record on a storage media for storage and analysis and can then upload the individual job record via a wireless link for storage and analysis.

If conditions have changed outside of specifications (Yes at Decision 130), then the system 10 alerts the applicator's device 72, 74, the worker's device 80, and/or the pumping apparatus 20 to stop the application until conditions return back to specifications. Therefore, operations can revert back to monitoring conditions until the coating process can be performed (Decision 120).

It is briefly noted that upon a reading this disclosure, those skilled in the art will recognize various means for carrying out these intended features of the present disclosure. As such it is to be understood that other methods, applications and systems adapted to the task may be configured to carry out these features and are therefore considered to be within the scope and intent of the present disclosure, and are anticipated. With respect to the above description, before explaining at least one preferred embodiment of the herein disclosed system in detail, it is to be understood that the present disclosure is not limited in its application to the details of construction and to the arrangement of the components in the following description or illustrated in the drawings. The system herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present disclosure. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present disclosure, as well as the advantages thereof over existing prior art, which will become apparent from the description to follow, are accomplished by the improvements described in this specification and hereinafter described in the following detailed description which fully discloses the subject matter, but should not be considered as placing limitations thereon.

It is additionally noted and anticipated that although the system and method are shown in their most simple form, various components and aspects of the present disclosure may be differently shaped or slightly modified when forming the disclosed system and method herein. As such those skilled in the art will appreciate the descriptions and depictions set forth in this disclosure or merely meant to portray examples of preferred modes within the overall scope and intent of the present disclosure, and are not to be considered limiting in any manner. While all of the fundamental characteristics and features of the present disclosure have been shown and described herein, with reference to particular embodiments thereof, a latitude of modification, various changes and substitutions are intended in the foregoing disclosure and it will be apparent that in some instances, some features of the present disclosure may be employed without a corresponding use of other features without departing from the scope of the present disclosure as set forth. It should also be understood that various substitutions, modifications, and variations may be made by those skilled in the art without departing from the scope of the present disclosure.

What is claimed is:

1. A system for applications of a spray coating, the system comprising:
a pumping apparatus configured to pump the spray coating;
an applicator in communication with the pumping apparatus and configured to apply the pumped spray coating;
an integrated environmental monitoring apparatus configured to monitor for one or more changes in one or more conditions and configured to notify at least one component of the system when at least one of the one or more conditions exceeds a programmed setpoint.

2. The system of claim 1, wherein the environmental monitoring sensors are remotely mounted in proximity to the applicator and communicate wirelessly to the pumping apparatus.

3. The system of claim 1, wherein the environmental monitoring sensors are remotely mounted in proximity to the applicator and communicate via a wired connection to the pumping apparatus.

4. The system of claim 1, wherein the environmental monitoring sensors comprises independent sensors configured to measure a plurality of the one or more conditions selected from the group consisting of wind speed, wind direction, ambient temperature, humidity, barometric pressure, substrate moisture content, and substrate temperature.

5. The system of claim 1, comprising a control unit configured to monitor the integrated environmental monitoring sensors for individual ones of the applications, the control unit having a communication interface configured to upload the individual applications via a wireless link for storage and analysis.

6. The system of claim 1, comprising a control unit configured to monitor the integrated environmental monitoring sensors for individual ones of the applications, the control unit configured to record the individual applications on a storage media for storage and analysis.

7. The system of claim 1, wherein the pumping apparatus is comprised of a single component pump.

8. The system of claim 1, wherein the pumping apparatus is comprised of a plurality of pumps for multiple component spray applied systems.

9. The system of claim 1, wherein the integrated environmental monitoring apparatus is configured to notify at least one of the a cellphone, a peripheral device, the application, and the application as the at least one component of the system with an alert indicative of the at least one of the one or more conditions exceeding the programmed setpoint.

10. The system of claim 1, wherein the integrated environmental monitoring apparatus is configured to notify at least one of the pumping apparatus and the applicator with a shutdown control.
